(19) United States
(12) Patent Application Publication
(10) Pub. No.: US 2024/0332536 A1
(43) Pub. Date: Oct. 3, 2024

(54) SOLID-STATE SECONDARY BATTERY AND METHOD FOR MANUFACTURING SAME

(71) Applicant: HONDA MOTOR CO., LTD., Tokyo (JP)

(72) Inventors: Takashi NAKAGAWA, Saitama (JP); Yohei NOJI, Saitama (JP); Hiroki ICHIHARA, Saitama (JP); Kyohei IZUMI, Saitama (JP)

(21) Appl. No.: 18/621,128

(22) Filed: Mar. 29, 2024

(30) Foreign Application Priority Data
Mar. 31, 2023 (JP) 2023-059656

(51) Int. Cl. H01M 4/62; H01M 50/105; H01M 50/474

(52) U.S. Cl. CPC H01M 4/628; H01M 50/105; H01M 50/474

(57) ABSTRACT

A solid-state secondary battery of this invention includes: an electrode multilayer; and an exterior case that houses the electrode multilayer, the electrode multilayer includes a positive electrode layer, a negative electrode layer, a solid electrolyte layer arranged between the positive electrode layer and the negative electrode layer and an intermediate layer provided between the negative electrode layer and the solid electrolyte layer, the positive electrode layer includes a positive electrode current collector and a positive electrode active material layer and when the area of the positive electrode active material layer in plan view is Sp, the area of the solid electrolyte layer in plan view is Ss, the area of the intermediate layer in plan view is Sm and the area of the negative electrode layer in plan view is Sn, a relationship of Sp<Sn≤Sm≤Ss is satisfied.

This application is based on and claims the benefit of priority from Japanese Patent Application No. 2023-059656, filed on 31 Mar. 2023, the content of which is incorporated herein by reference.

### BACKGROUND OF THE INVENTION

### Field of the Invention

The present invention relates to a solid-state secondary battery and a method for manufacturing the solid-state secondary battery.

### Related Art

In recent years, research and development has been conducted on secondary batteries which contribute to energy efficiency in order to ensure that more people have access to affordable, reliable, sustainable and advanced energy. Among secondary batteries, in particular, attention is focused on a solid-state secondary battery which uses a solid electrolyte because the solid-state secondary battery is excellent in that the solid electrolyte is non-flammable to enhance safety and the solid-state secondary battery has a higher energy density.

In the solid-state secondary battery, charging and discharging is repeated, and thus metal ions such as lithium ions which are used as a charge transfer medium may be precipitated between a solid electrolyte layer and a negative electrode layer. For example, the bondability of interfaces is lowered by the precipitation of the metal described above, and thus the performance of the solid-state secondary battery may be lowered. A technique for solving the problem described above is known, and in the technique, a layer on which lithium metal for covering a negative electrode current collector can be precipitated is provided, thus the lithium metal is substantially uniformly precipitated on the surface of a covering layer and consequently, dead lithium is unlikely to be generated (see, for example, Patent Document 1).
Patent Document 1: Japanese Unexamined Patent Application, Publication No. 2018-129159

### SUMMARY OF THE INVENTION

Incidentally, in the solid-state secondary battery, it has been desired to enhance cycle characteristics. However, when a layer (intermediate layer) on which metal can be precipitated between the solid electrolyte layer and the negative electrode current collector is provided, if dimensions, a structural design and process conditions are inappropriate, charging and discharging is repeated, and thus it is likely that metal ions serving as a charge transfer medium are easily precipitated at end portions of the solid electrolyte layer and the intermediate layer. When the metal ions are precipitated at the end portions of the solid electrolyte layer and the intermediate layer, the precipitated metal is accumulated, and thus a positive electrode layer and the negative electrode layer may be short-circuited or a side reaction may occur locally to increase resistance, with the result that the cycle characteristics may be lowered.

The present invention is made in view of the foregoing, and an object of the present invention is to provide a solid-state secondary battery in which even when charging and discharging is repeated, a positive electrode layer and a negative electrode layer are unlikely to be short-circuited and a method for manufacturing the solid-state secondary battery. Then, this contributes to an increase in energy efficiency.

The present inventors have found that the areas of a positive electrode active material layer, a solid electrolyte layer, an intermediate layer and a negative electrode layer in plan view are adjusted to satisfy a predetermined relationship, and thus it is possible to solve the problem described above, with the result that the present inventors have achieved the present invention. Hence, the present invention provides the following aspects.

(1) A solid-state secondary battery including: an electrode multilayer; and an exterior case that houses the electrode multilayer, in which the electrode multilayer includes a positive electrode layer, a negative electrode layer, a solid electrolyte layer arranged between the positive electrode layer and the negative electrode layer and an intermediate layer provided between the negative electrode layer and the solid electrolyte layer, the positive electrode layer includes a positive electrode current collector and a positive electrode active material layer and when an area of the positive electrode active material layer in plan view is Sp, an area of the solid electrolyte layer in plan view is Ss, an area of the intermediate layer in plan view is Sm and an area of the negative electrode layer in plan view is Sn, a relationship of Sp<Sn≤Sm≤Ss is satisfied.

In the solid-state secondary battery of (1), the areas of the positive electrode active material layer, the solid electrolyte layer, the intermediate layer and the negative electrode layer in plan view satisfy the relationship described above, and thus even when charging and discharging is repeated, a metal is unlikely to be accumulated at end portions of the solid electrolyte layer and the intermediate layer. Hence, the positive electrode layer and the negative electrode layer are unlikely to be short-circuited, and thus cycle characteristics are enhanced.

(2) The solid-state secondary battery described in (1), in which the Sm and the Sn satisfy the relationship Sn<Sm.

In the solid-state secondary battery of (2), since the area of the intermediate layer is greater than the area of the negative electrode layer, it is possible to prevent metal ions, which are charge transfer media, from extending around from end portions of the negative electrode layer to the positive electrode via the solid electrolyte layer, which is low density, to cause a short circuit. There is also an effect that this aspect eliminates the need to consider the likelihood that metal ions may deposit on the end portions of the intermediate layer.

(3) The solid-state secondary battery described in (1) or (2) above, in which when a direction parallel to an upper surface of the electrode multilayer viewed in plan view is a first direction, a distance from a center portion to an end portion of the positive electrode active material layer in the first direction is Xp, a distance from a center portion to an end portion of the solid electrolyte layer in the first direction is Xs, a distance from a center portion to an end portion of the intermediate layer in the first direction is Xm and a distance from a center portion to an end portion of the negative electrode layer in the first direction is Xn, a relationship of Xp<Xn≤Xm≤Xs is satisfied, and when a direction which is parallel to the upper surface of the electrode multilayer viewed in plan view and is orthogonal to the first direction is a second direction, a distance from a center portion to an end portion of the positive electrode active material layer in the second direction is Yp, a distance from a center portion to an end portion of the solid electrolyte layer in the second direction is Ys, a distance from a center portion to an end portion of the intermediate layer in the second direction is Ym and a distance from a center portion to an end portion of the negative electrode layer in the second direction is Yn, a relationship of Yp<Yn≤Ym≤Ys is satisfied.

In the solid-state secondary battery of (3), the distances from the center portions to the end portions of the positive electrode active material layer, the solid electrolyte layer, the intermediate layer and the negative electrode layer in the first direction and in the second direction satisfy the relationship described above, and thus even when charging and discharging is repeated, a metal is unlikely to be accumulated at the end portions of the solid electrolyte layer and the intermediate layer. Hence, the positive electrode layer and the negative electrode layer are more unlikely to be short-circuited, and thus the cycle characteristics are further enhanced.

(4) The solid-state secondary battery described in (3), in which the Xm and the Xn satisfy the relationship Xn<Xm and the Ym and the Yn satisfy the relationship Yn<Ym.

In the solid-state secondary batter described in (4), since the distance from a center portion to an end portion in the first direction or the second direction of the intermediate layer is greater than the distance from a center portion to an end portion in the first direction or the second direction of the negative electrode layer, respectively, it is possible to prevent metal ions, which are charge transfer media, from extending around from the end portions of the negative electrode layer to the positive electrode layer via the solid electrolyte layer, which is low density, to cause a short circuit. There is also an effect that this aspect eliminates the need to consider the likelihood that metal ions may deposit on the end portion of the intermediate layer.

(5) The solid-state secondary battery described in any one of (1) to (4) above, in which the outer periphery of the positive electrode active material layer is surrounded by an insulating frame.

In the solid-state secondary battery of (5), the outer periphery of the positive electrode active material layer is surrounded by the insulating frame, and thus even when a metal is accumulated at the end portions of the solid electrolyte layer and the intermediate layer, the metal is unlikely to extend around the positive electrode active material layer. Hence, the positive electrode layer and the negative electrode layer are more unlikely to be short-circuited, and thus the cycle characteristics are further enhanced.

(6) The solid-state secondary battery described in (5) above, in which when a direction parallel to an upper surface of the electrode multilayer viewed in plan view is a first direction, a distance from a center portion to an end portion of the insulating frame in the first direction is Xi, a distance from a center portion to an end portion of the positive electrode active material layer in the first direction is Xp, a distance from a center portion to an end portion of the solid electrolyte layer in the first direction is Xs, a distance from a center portion to an end portion of the intermediate layer in the first direction is Xm and a distance from a center portion to an end portion of the negative electrode layer in the first direction is Xn, a relationship of Xp<Xn≤Xm≤Xs<Xi is satisfied, and when a direction which is parallel to the upper surface of the electrode multilayer viewed in plan view and is orthogonal to the first direction is a second direction, a distance from a center portion to an end portion of the insulating frame in the second direction is Yi, a distance from a center portion to an end portion of the positive electrode active material layer in the second direction is Yp, a distance from a center portion to an end portion of the solid electrolyte layer in the second direction is Ys, a distance from a center portion to an end portion of the intermediate layer in the second direction is Ym and a distance from a center portion to an end portion of the negative electrode layer in the second direction is Yn, a relationship of Yp<Yn≤Ym≤Ys<Yi is satisfied.

In the solid-state secondary battery of (6), the distances from the center portions to the end portions of the insulating frame, the positive electrode active material layer, the solid electrolyte layer, the intermediate layer and the negative electrode layer in the first direction and in the second direction satisfy the relationship described above, and thus the positive electrode layer and the negative electrode layer are more unlikely to be short-circuited, and thus the cycle characteristics are further enhanced.

(7) The solid-state secondary battery described in any one of (1) to (6) above, in which the thickness of the intermediate layer in a stacking direction of the electrode multilayer is equal to or less than 5 μm.

In the solid-state secondary battery of (7), the thickness of the intermediate layer is equal to or less than 5 μm, and thus the position of precipitation of a metal serving as a charge transfer medium during charging can be located between the intermediate layer and the negative electrode layer. In this way, the frequency of direct contact between the solid electrolyte layer and the precipitated metal can be significantly reduced, and local deterioration and current concentration in the solid electrolyte layer can be suppressed, with the result that the cycle characteristics and storage properties are enhanced. The relatively elastic intermediate layer can be arranged between the hard solid electrolyte layer and the precipitated metal, thus it is easy to follow expansion and contraction caused by the precipitation and dissolution of the metal and thereby a uniform reaction can be performed in a plane and in the direction of the thickness, with the result that the effects of reducing resistance and enhancing the cycle characteristics are obtained.

(8) In the solid-state secondary battery described in any one of (1) to (7) above, the intermediate layer includes metal nanoparticles and amorphous carbon.

In the solid-state secondary battery of (8), it is possible to ensure the electronic conductivity of the intermediate layer, and to prevent the particles of the intermediate layer from reacting with the charge transfer medium to form an alloy.

(9) The solid-state secondary battery described in any one of (1) to (8) above, in which the ratio of the thickness of the positive electrode layer to the thickness of the negative electrode layer in a discharged state is equal to or greater than 1.9.

In the solid-state secondary battery of (9), the ratio of the thickness of the positive electrode layer to the thickness of the negative electrode layer is the value described above, and thus it is possible to ensure a clearance between the electrode multilayer and the exterior case. The clearance is ensured, and thus it is possible to prevent the electrode multilayer from making excessive contact with a tab leading portion which draws the exterior case or a positive electrode tab or a negative electrode tab to the outside. When the electrode multilayer is expanded and contracted by charging and discharging, the positive electrode tab or the negative electrode tab easily follows the expansion and contraction of the electrode multilayer.

(10) The solid-state secondary battery described in any one of (1) to (9) above including: a restrainer that provides a restraint force to the electrode multilayer in the stacking direction of the electrode multilayer, in which when the area of the restrainer in plan view is Sr, a relationship of Sn≤Sr is satisfied.

In the solid-state secondary battery of (10), the electrode multilayer is restrained by the restrainer which satisfies the relationship described above, and thus a metal can be uniformly precipitated on the surface of the negative electrode layer, with the result that the metal is unlikely to be accumulated at the end portions of the solid electrolyte layer and the intermediate layer. Hence, the positive electrode layer and the negative electrode layer are more unlikely to be short-circuited, and thus the cycle characteristics are further enhanced.

(11) A method for manufacturing a solid-state secondary battery including: preparing a positive electrode layer that includes a positive electrode current collector and a positive electrode active material layer; forming a solid electrolyte layer on the surface of the positive electrode active material layer of the positive electrode layer; forming an intermediate layer on the surface of the solid electrolyte layer on a side opposite to the side of the positive electrode active material layer; and forming a negative electrode layer on the surface of the intermediate layer on a side opposite to the side of the solid electrolyte layer.

In the method for manufacturing a solid-state secondary battery of (11), after the intermediate layer is formed on the surface of the solid electrolyte layer, the negative electrode layer is formed on the surface of the intermediate layer, and thus it is possible to industrially advantageously manufacture the solid-state secondary battery in which the areas of the solid electrolyte layer, the intermediate layer and the negative electrode layer in plan view satisfy a relationship of Sn≤Sm≤Ss.

According to the present invention, it is possible to provide a solid-state secondary battery in which even when charging and discharging is repeated, a positive electrode layer and a negative electrode layer are unlikely to be short-circuited and a method for manufacturing the solid-state secondary battery.

### BRIEF DESCRIPTION OF THE DRAWINGS

FIG. 1 is a top view of the electrode multilayer of a solid-state secondary battery according to an embodiment of the present invention;

FIG. 2 is a cross-sectional view taken along line II-II in FIG. 1;

FIG. 3 is a cross-sectional view showing a charged state of the electrode multilayer shown in FIG. 2; and

FIG. 4 is a cross-sectional view of the solid-state secondary battery according to the embodiment of the present invention.

### DETAILED DESCRIPTION OF THE INVENTION

An embodiment of the present invention will be described below with reference to drawings. However, the embodiment described below illustrates the present invention, and the present invention is not limited to the following embodiment.

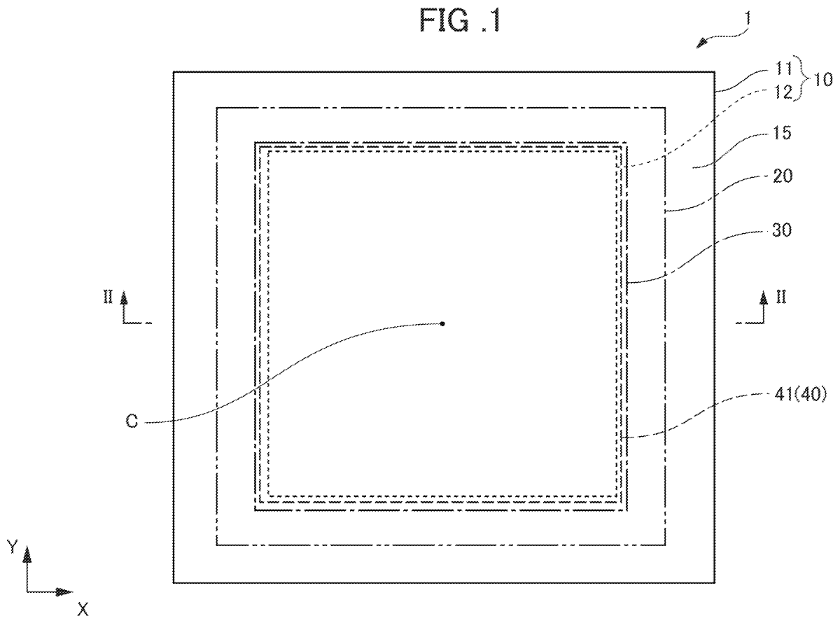

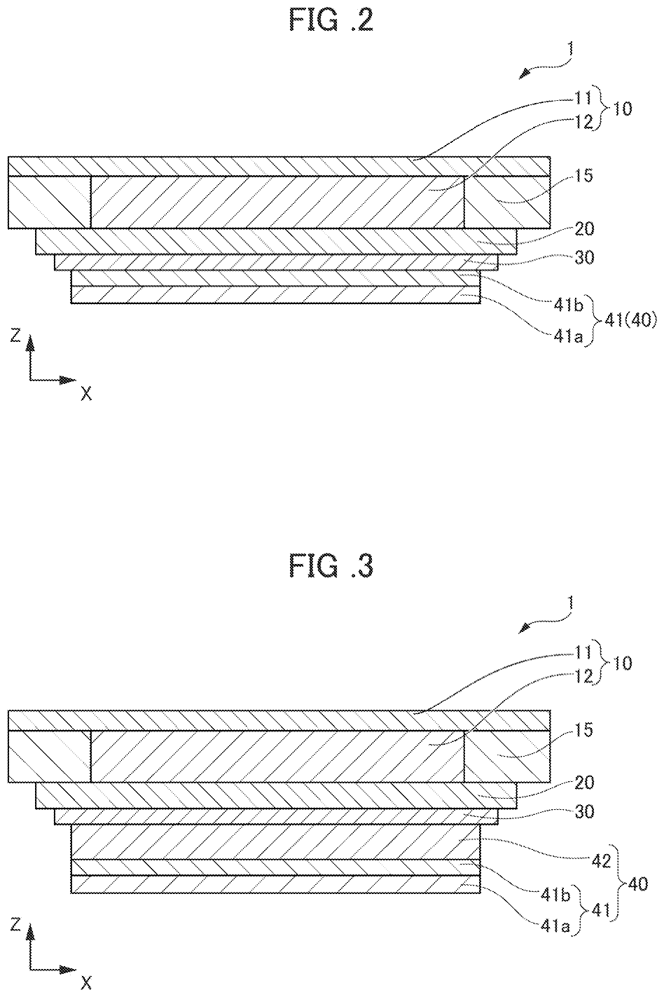

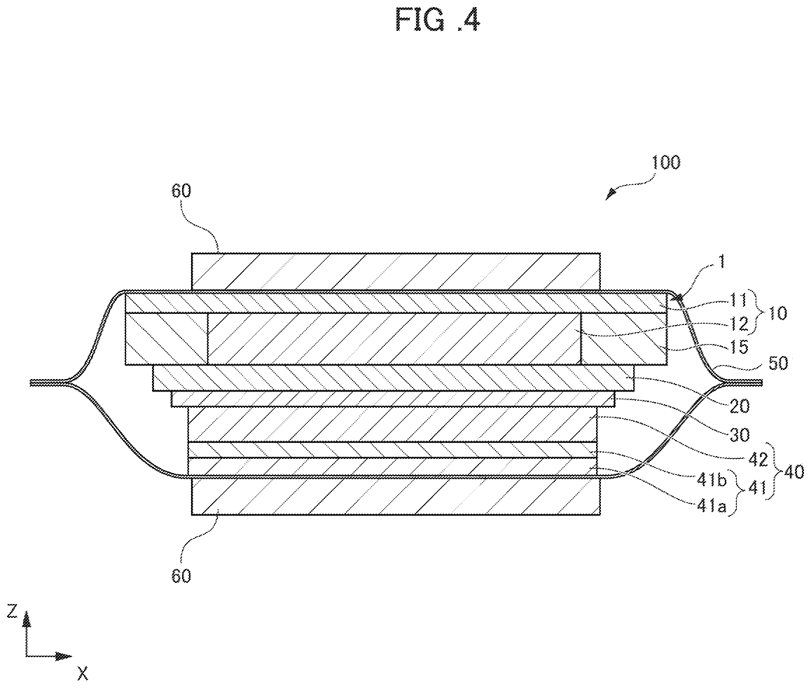

FIG. 1 is a top view of the electrode multilayer of a solid-state secondary battery according to the embodiment of the present invention. FIG. 2 is a cross-sectional view taken along line II-II in FIG. 1, and FIG. 3 is a cross-sectional view showing a charged state of the electrode multilayer shown in FIG. 2. FIG. 4 is a cross-sectional view of the solid-state secondary battery which includes the electrode multilayer shown in FIGS. 1 to 3. In FIGS. 1 to 4, an X direction indicated by an arrow X is a direction (first direction) which is parallel to an upper surface when the electrode multilayer is viewed in plan view. A Y direction indicated by an arrow Y is a direction (second direction) which is parallel to the upper surface when the electrode multilayer is viewed in plan view and is orthogonal to the X direction. A Z direction indicated by an arrow Z is a stacking direction of the electrode multilayer.

As shown in FIG. 4, the solid-state secondary battery 100 of the present embodiment includes the electrode multilayer 1. As shown in FIGS. 1 to 3, the electrode multilayer 1 is a multilayer in which the positive electrode layer 10, a solid electrolyte layer 20, an intermediate layer 30 and a negative electrode layer 40 are stacked in this order. The positive electrode layer 10 includes a positive electrode current collector 11 and a positive electrode active material layer 12. The outer periphery of the positive electrode active material layer 12 is surrounded by an insulating frame 15. The negative electrode layer 40 includes a negative electrode current collector 41. The electrode multilayer 1 shown in FIGS. 1 and 2 is in a discharged state, and the electrode multilayer 1 shown in FIG. 3 is in a charged state. The negative electrode layer 40 in the charged state includes a metal precipitation layer 42 which is generated by precipitating metal ions serving as a charge negative electrode active material on the surface of the negative electrode current collector 41 on the side of the intermediate layer 30. The metal precipitation layer 42 acts as a negative electrode active material layer, and releases the metal ions during discharging. The thickness of the negative electrode layer 40 of the electrode multilayer 1 is changed by charging and discharging.

As shown in FIG. 1, the electrode multilayer 1 is a rectangle in which its length in the X direction is longer than that in the Y direction in plan view. The electrode multilayer 1 may be square or circular in plan view.

When the area of the positive electrode active material layer 12 in plan view is Sp, the area of the solid electrolyte layer 20 in plan view is Ss, the area of the intermediate layer 30 in plan view is Sm and the area of the negative electrode layer 40 in plan view is Sn, the electrode multilayer 1 satisfies a relationship of Sp<Sn≤Sm≤Ss. In the present embodiment, a relationship of the areas of the layers is Sp<Sn=Sm<Ss. The relationship of the areas of the layers may be Sp<Sn<Sm=Ss, Sp<Sn=Sm=Ss or Sp<Sn<Sm<Ss. The areas of the layers satisfy the relationship described above, and thus the electrode multilayer 1 has a configuration in plan view in which an end portion of the positive electrode active material layer 12 is innermost and end portions of the other layers (the solid electrolyte layer 20, the intermediate layer 30 and the negative electrode layer 40) are outside of the end portion of the positive electrode active material layer 12. In the electrode multilayer 1 configured as described above, the end portion of the positive electrode active material layer 12 is away from the end portions of the other layers, and thus metal ions (charge transfer medium) which are released from the positive electrode active material layer 12 during charging are unlikely to be precipitated at the end portions of the other layers. Hence, even when charging and discharging is repeated, the metal is unlikely to be accumulated at the end portions of the solid electrolyte layer 20 and the intermediate layer 30. The ratio Sn/Sp of the area Sn of the negative electrode layer 40 to the area Sp of the positive electrode active material layer 12 may be, for example, in a range of 1.05 to 1.45. The ratio Sm/Sp of the area Sm of the intermediate layer 30 to the area Sp of the positive electrode active material layer 12 may be, for example, in a range of 1.10 to 1.45. The ratio Ss/Sp of the area Ss of the solid electrolyte layer 20 to the area Sp of the positive electrode active material layer 12 may be, for example, in a range of 1.25 to 2.00.

In the electrode multilayer 1, distances from a center portion C to the end portions of the insulating frame 15 and the other layers in the X direction (first direction) preferably satisfy a relationship of Xp<Xn≤Xm≤Xs<Xi. Xp is the distance from the center portion C to the end portion of the positive electrode active material layer 12 in the X direction, Xn is the distance from the center portion C to the end portion of the negative electrode layer 40 in the X direction, Xm is the distance from the center portion C to the end portion of the intermediate layer 30 in the X direction, Xs is the distance from the center portion C to the end portion of the solid electrolyte layer 20 in the X direction and Xi is the distance from the center portion C to the end portion of the insulating frame 15 in the X direction. In the present embodiment, the relationship of the distances is Xp<Xn=Xm<Xs<Xi. The relationship of the distances may be Xp<Xn<Xm=Xs<Xi, Xp<Xn=Xm=Xs<Xi or Xp<Xn<Xm<Xs<Xi.

Distances from the center portion C to the end portions of the insulating frame 15 and the other layers in the Y direction (second direction) preferably satisfy a relationship of Yp<Yn≤Ym≤Ys<Yi. Yp is the distance from the center portion C to the end portion of the positive electrode active material layer 12 in the Y direction, Yn is the distance from the center portion to the end portion of the negative electrode layer 40 in the Y direction, Ym is the distance from the center portion C to the end portion of the intermediate layer 30 in the Y direction, Ys is the distance from the center portion C to the end portion of the solid electrolyte layer 20 in the Y direction and Yi is the distance from the center portion C to the end portion of the insulating frame 15 in the Y direction. In the present embodiment, the relationship of the distances is Yp<Yn=Ym<Ys<Yi. The relationship of the distances may be Yp<Yn<Ym=Ys<Yi, Yp<Yn=Ym=Ys<Yi or Yp<Yn<Ym<Ys<Yi.

The distances in the X direction satisfy Xp<Xn<Xi, the distances in the Y direction satisfy Yp<Yn<Yi and thus the density of the solid electrolyte layer 20 can be increased, with the result that it is possible to suppress the extension of the metal from the end portion of the solid electrolyte layer 20. The distances in the X direction satisfy Xp<Xn≤Xm≤Xs, the distances in the Y direction satisfy Yp<Yn≤Ym≤Ys and thus the solid electrolyte layer 20 and the metal precipitation layer 42 do not make direct contact with each other even at the end portion of the solid electrolyte layer 20. Hence, it is possible to suppress the infiltration of the metal and the precipitation of the metal to the solid electrolyte layer 20, and to suppress the reductive decomposition of the solid electrolyte layer 20. Furthermore, the distances in the X direction satisfy Xp<Xn≤Xm≤Xs<Xi, the distances in the Y direction satisfy a relationship of Yp<Yn≤Ym≤Ys<Yi and thus even when the metal is accumulated at the end portions of the solid electrolyte layer 20 and the intermediate layer 30, the metal is unlikely to extend around the positive electrode active material layer. Furthermore, the relationship described above is satisfied, and thus when the electrode multilayer 1 is pressed in the stacking direction and thus the density of the electrode multilayer 1 is increased, the influence of a step of the thicknesses of the positive electrode active material layer 12 and the insulating frame 15 can be reduced, with the result that the density of the entire solid electrolyte layer 20 opposite the negative electrode layer 40 can be increased.

As long as the positive electrode current collector 11 has the function of collecting current from the positive electrode layer 10, the material and the shape thereof are not particularly limited. The area of the positive electrode current collector 11 in plan view is preferably equal to or greater than that of the positive electrode active material layer 12. Examples of the material of the positive electrode current collector 11 include aluminum, an aluminum alloy, stainless steel, nickel, iron, titanium and the like, and among them, aluminum, an aluminum alloy and stainless steel are preferable. Examples of the shape of the positive electrode current collector 11 include a foil shape, a plate shape and the like.

The positive electrode active material layer 12 contains at least one type of positive electrode active material. The positive electrode active material is not particularly limited, and a positive electrode active material which is used in the positive electrode layer of a general solid-state secondary battery can be used. Examples of the positive electrode active material include a lithium-containing layered active material, a spinel-type active material, an olivine-type active material and the like. Specific examples of the positive electrode active material include lithium cobalt oxide (LiCoO₂), lithium nickel oxide (LiNiO₂), LiNiₚMn_{q}CoᵣO₂ (p+q+r=1), LiNiₚAl_{q}CoᵣO₂ (p+q+r=1), lithium manganate (LiMn₂O₄), a different element substituted Li—Mn spinel represented by Li₁₊ₓMn_{2-x-y}MO₄ (x+y=2, M=at least one selected from Al, Mg, Co, Fe, Ni and Zn), lithium titanate (oxide including Li and Ti), lithium metal phosphate (LiMPO₄, M=at least one selected from Fe, Mn, Co and Ni) and the like.

In terms of enhancing the conductivity of the charge transfer medium, the positive electrode active material layer 12 may optionally include a solid electrolyte. The positive electrode active material layer 12 may optionally include a conductive aid in order to enhance the conductivity. Furthermore, for example, in terms of developing flexibility, the positive electrode active material layer 12 may optionally include a binder. The solid electrolyte, the conductive aid and the binder are not particularly limited, and a solid electrolyte, a conductive aid and a binder which are used in the positive electrode layer of a general solid-state secondary battery can be used.

The volume resistivity of the insulating frame 15 at 20° C. may be equal to or greater than 1×10¹² Ω·cm. The insulating frame 15 may be made of an organic or inorganic material. Examples of the material of the insulating frame 15 include rubber, glass, resins (such as polyimide, polybenzimidazole, polyamideimide, polyetherimide, polyacetal, polyphenylene sulfide, polyetheretherketone, tetrafluoroethylene, 6-polyamide (6-nylon), ultra-high molecular weight polyethylene, polyethylene, polypropylene, vinyl chloride resin, polystyrene, polyethylene terephthalate and ABS resin) and ceramics (alumina, zirconia, silicon nitride, aluminum nitride, mullite, steatite, magnesia, sialon and macerite). The dielectric breakdown voltage per unit thickness of the insulating frame 15 is preferably equal to or greater than 10 kV/mm, and more preferably equal to or greater than 100 kV/mm. The material of the insulating frame 15 may be a single material or a composite material, and may include a small amount of binder or additive.

The solid electrolyte layer 20 is a layer which is stacked between the positive electrode layer 10 and the negative electrode layer 40. The solid electrolyte layer 20 contains at least one type of solid electrolyte material. The solid electrolyte layer 20 can conduct the charge transfer medium between the positive electrode layer 10 and the negative electrode layer 40 via the solid electrolyte material included in the solid electrolyte layer 20.

Although the solid electrolyte material is not particularly limited as long as the solid electrolyte material has the conductivity of a charge transfer medium, examples of the solid electrolyte material which can be used include a sulfide solid electrolyte material, an oxide solid electrolyte material, a nitride solid electrolyte material, a halide solid electrolyte material and the like.

Examples of the sulfide solid electrolyte material include Li₂S—P₂S₅, Li₂S—P₂S₅—LiI and the like. The “Li₂S—P₂S₅” described above means a sulfide solid electrolyte material which is formed using a raw material composition including Li₂S—P₂S₅, and the same is true for the same other descriptions. The sulfide solid electrolyte material may have an argillodite type crystal structure.

Examples of the oxide solid electrolyte material include a NASICON type oxide, a garnet type oxide, a perovskite type oxide and the like. Examples of the NASICON type oxide include oxides containing Li, Al, Ti, P and O (for example, Li_{1.5}Al_{0.5}Ti_{1.5}(PO₄)₃). Examples of the garnet type oxide include oxides containing Li, La, Zr and O (for example, Li₇La₃Zr₂O₁₂). Examples of the perovskite type oxide include oxides containing Li, La, Ti and O (for example, LiLaTiO₃).

The solid electrolyte layer 20 may include a binder. The binder is not particularly limited, and a binder which is used in the solid electrolyte layer of a general solid-state secondary battery can be used.

The porosity of the solid electrolyte layer 20 is lower than that of the intermediate layer 30 described later, and is, for example, less than 10%. As the particle diameter of the solid electrolyte material of the solid electrolyte layer 20, for example, the median diameter (D50) thereof is 0.5 to 10 μm, and is preferably greater than that of the particles of the intermediate layer 30 described later.

For example, the porosity of the solid electrolyte layer 20 can be determined by formula (1) below. A “filling rate” in formula (1) means the percentage of the density of the solid electrolyte layer after being formed relative to a true density.

$$porosity ( \% ) = 100 - filling rate ( \% ) \qquad ( 1 )$$

The intermediate layer 30 is a layer which is stacked between the solid electrolyte layer 20 and the negative electrode layer 40. The intermediate layer 30 has the function of suppressing non-uniform precipitation of metal ions on the interface of the negative electrode layer 40 and thereby enhancing interfacial adhesion.

Preferably, the intermediate layer 30 has electronic conductivity, and includes voids through which the metal ions (for example, lithium ions) serving as a charge transfer medium can be passed. The intermediate layer 30 includes the voids, and thus when the solid-state secondary battery 100 is charged, the metal ions which are transferred from the solid electrolyte layer 20 to the negative electrode layer 40 are passed though the intermediate layer 30 and are precipitated on the surface of the negative electrode current collector 41 of the negative electrode layer 40 on the side of the intermediate layer 30, with the result that the metal precipitation layer 42 (layer of metallic lithium) is generated. The metal ions are passed through the intermediate layer 30, and thus the metal precipitation layer 42 can be uniformly generated on the surface of the negative electrode current collector 41. The intermediate layer 30 includes the voids, and thereby has such pliability as to be able to follow a change in the thickness of the negative electrode layer 40 caused by charging and discharging. Hence, even when charging and discharging is repeated in the solid-state secondary battery 100, interfacial adhesion can be maintained, and durability of the solid-state secondary battery 100 can be enhanced.

The porosity of the intermediate layer 30 is preferably higher than that of the solid electrolyte layer 20. In this way, a large number of voids through which the metal ions can be passed are formed inside the intermediate layer 30, and thus the metal precipitation layer 42 can be more uniformly generated on the surface of the negative electrode current collector 41. The intermediate layer 30 is more pliable, and thus the property of following a change in the thickness of the negative electrode layer 40 can be further enhanced. The porosity of the intermediate layer 30 can be, for example, 40 to 70%. As a method for calculating the porosity of the intermediate layer 30, the same method as the method for calculating the porosity of the solid electrolyte layer 20 can be applied.

The thickness of the intermediate layer 30 may be equal to or less than 5 μm. The thickness of the intermediate layer 30 is equal to or less than 5 μm, and thus the position of precipitation of the metal serving as the charge transfer medium during charging can be located between the intermediate layer 30 and the negative electrode layer 40. In this way, the frequency of direct contact between the solid electrolyte layer 20 and the precipitated metal can be greatly reduced, and local deterioration of the solid electrolyte layer 20 and current concentration can be suppressed, with the result that the cycle characteristics and storage properties are enhanced. The relatively elastic intermediate layer 30 can be arranged between the hard solid electrolyte layer 20 and the precipitated metal, thus it is easy to follow expansion and contraction caused by the precipitation and dissolution of the metal and thereby a uniform reaction can be performed in a plane and in the direction of the thickness, with the result that the effects of reducing resistance and enhancing the cycle characteristics are obtained. Furthermore, in order to obtain the effects of reducing resistance and enhancing the cycle characteristics, the thickness of the intermediate layer may be equal to or less than 3 μm or may be in a range of 1 to 3 μm.

The intermediate layer 30 preferably includes amorphous carbon and metal nanoparticles. The intermediate layer 30 may further include a binder as a binding material in order to retain its structure.

The amorphous carbon is different from, for example, graphite or the like, and is unlikely to react with a metal such as lithium to form an alloy, and thus it is possible to suppress the formation of dendrite, with the result that the cycle characteristics of the solid-state secondary battery can be enhanced. The amorphous carbon may be easily graphitizable carbon (soft carbon) or poorly graphitizable carbon (hard carbon). Among allotropes of carbon, the amorphous carbon is preferably an allotrope which does not exhibit a distinct crystalline state, and may be an aggregate of fine graphite crystals. Specific examples of the amorphous carbon include carbon blacks such as acetylene black, furnace black and Ketjen black, coke, activated carbon, CNT (carbon nanotube), fullerene and graphene.

Examples of the metal nanoparticles include metal nanoparticles of tin (Sn), silicon (Si), zinc (Zn), magnesium (Mg), gold (Au), platinum (Pt), palladium (Pd), silver (Ag), aluminum (Al), bismuth (Bi), antimony (Sb) and the like. The content of the metal nanoparticles in the intermediate layer 30 is preferably greater than 0% by mass and equal to or less than 30% by mass. The intermediate layer 30 includes the metal nanoparticles, and thus it is possible to enhance the electronic conductivity of the intermediate layer 30, with the result that it is possible to generate the metal precipitation layer 42 more uniformly. The metal nanoparticles have a higher Young's modulus than the amorphous carbon, and thus even when the metal nanoparticles are pressed with a high pressure during manufacturing of the solid-state secondary battery 100, the structure of the intermediate layer 30 can be retained.

The particle diameters of the amorphous carbon, the metal nanoparticles and the like are preferably smaller than the particle diameter of the solid electrolyte material. In this way, the intermediate layer 30 can enter gaps of the solid electrolyte material which constitute the interface of the solid electrolyte layer 20, and thus the contact area of the solid electrolyte layer 20 and the intermediate layer 30 can be increased, and the adhesion thereof can be enhanced. As the particle diameter of the amorphous carbon, for example, the median diameter (D50) thereof may be in a range of 0.02 to 0.10 μm. As the particle diameter of the metal nanoparticles, for example, the median diameter (D50) thereof may be in a range of 0.02 to 0.20 μm.

The binder is preferably a binder which can enhance adhesion of the particles of the intermediate layer 30 and adhesion of the intermediate layer 30 and the solid electrolyte layer 20. The binder is not particularly limited, and a binder which is used in a general solid-state secondary battery can be used. Examples of the binder include acrylic acid polymers, cellulose polymers, styrene polymers, vinyl acetate polymers, urethane polymers, fluoroethylene polymers and PVDF polymers.

The negative electrode current collector 41 is a multilayer which includes a current collection base member 41a and a metal layer 41b stacked on the surface of the current collection base member 41a. The material and the shape of the current collection base member 41a are not particularly limited as long as the current collection base member 41a has the function of collecting current from the negative electrode layer 40. Examples of the material of the current collection base member 41a include nickel, copper, stainless steel and the like. Examples of the shape of the current collection base member 41a include a foil shape, a plate shape and the like.

The material and the shape of the metal layer 41b are not particularly limited as long as the metal layer 41b has the function of densely precipitating a charge transfer medium such as lithium ions. When the charge transfer medium is lithium ions, as the material of the metal layer 41b, metallic lithium or a metal which generates an alloy with lithium can be used. Examples of the metal which forms an alloy with lithium include Mg, Si, Au, Ag, In, Ge, Sn, Pb, Al, Zn and the like. The metal of the metal layer 41b may be in the shape of powder or may be in the shape of a thin film. The negative electrode current collector 41 which includes the metal layer 41b is used, and thus the metal precipitation layer 42 can be uniformly generated on the surface of the negative electrode current collector 41. The metal layer 41b is omitted, and thus lithium ions may be directly precipitated on the current collection base member 41a.

As shown in FIG. 4, the electrode multilayer 1 is housed in the exterior case 50. On the outer surfaces of the exterior case 50, a pair of restrainers 60 for providing a restraint force to the electrode multilayer 1 are arranged. The solid-state secondary battery 100 includes: a positive electrode tab (not shown) in which one end portion is connected to the positive electrode current collector 11 and the other end portion protrudes outward; and a negative electrode tab (not shown) in which one end portion is connected to the negative electrode current collector 41 and the other end protrudes outward.

The exterior case 50 can be expanded and contracted as the thickness of the negative electrode is changed by charging and discharging. As the material of the exterior case 50, a laminate film can be used. As the laminate film, a multilayer film of a three-layer structure can be used in which an inner resin layer, a metal layer and an outer resin layer are stacked in this order from inside. The outer resin layer may be, for example, a polyamide (nylon) layer or a polyethylene terephthalate (PET) layer, the metal layer may be, for example, an aluminum layer and the inner resin layer may be, for example, a polyethylene layer or a polypropylene layer. An adhesive layer may be included between the layers or may be integrated by heat, pressure or the like.

In order to ensure a clearance inside the exterior case 50, the ratio (thickness of the positive electrode layer 10/thickness of the negative electrode layer 40) of the thickness of the positive electrode layer 10 to the thickness (thickness of the negative electrode current collector 41) of the negative electrode layer 40 in a discharged state may be equal to or greater than 1.9.

The restrainers 60 provide the restraint force in the stacking direction of the electrode multilayer 1. When the area of the restrainers 60 in plan view is Sr, and the area of the negative electrode layer 40 in plan view is Sn, a relationship of Sn≤Sr is preferably satisfied. The area Sr of the restrainers 60 satisfies the relationship, and thus the restraint force uniformly acts on the surface of the negative electrode layer 40. Hence, during charging, the metal ions can be uniformly precipitated on the surface of the negative electrode layer 40, and thus the metal is unlikely to be accumulated at the end portions of the solid electrolyte layer 20 and the intermediate layer 30. The material of the restrainers 60 is not particularly limited, and a material which is used in a general solid-state battery can be used. The restraint force exerted by the restrainers 60 on the electrode multilayer 1 may be, for example, in a range of 0.1 to 10 MPa.

Next, method for manufacturing the solid-state secondary battery 100 in the present embodiment will be described. The electrode multilayer 1 can be produced by a method which includes: preparing a positive electrode layer; forming a solid electrolyte layer; forming an intermediate layer; and forming a negative electrode layer.

The preparing of a positive electrode layer is preparing the positive electrode layer 10. The positive electrode layer 10 can be produced, for example, by forming the positive electrode active material layer 12 on the surface of the positive electrode current collector 11. As a method of forming the positive electrode active material layer 12, a method of applying and drying a positive electrode active material layer slurry can be used. As the positive electrode active material layer slurry, a dispersion liquid of a positive electrode active material which contains a solvent and a positive electrode active material and optionally contains a conductive aid and a binder can be used. In the preparing of a positive electrode layer, the insulating frame 15 is preferably arranged to surround the outer periphery of the positive electrode active material layer 12.

The forming of a solid electrolyte layer is forming the solid electrolyte layer 20 on the surface of the positive electrode active material layer 12 of the positive electrode layer 10. As a method of forming the solid electrolyte layer 20, a method of directly applying and drying a solid electrolyte layer slurry on the surface of the positive electrode active material layer 12 or a method of transferring the solid electrolyte layer 20 formed by applying and drying the solid electrolyte layer slurry on the surface of a support sheet prepared separately to the surface of the positive electrode active material layer 12 with a predetermined pressure can be used. As the solid electrolyte layer slurry, for example, a dispersion liquid of a solid electrolyte which contains a solvent and a solid electrolyte and optionally contains a binder can be used. As a method of forming the solid electrolyte layer 20, a method of integrating the solid electrolyte layer with a base member, making it independent and then arranging it on the positive electrode layer can be used. As the base member, for example, non-woven fabric or woven fabric can be used. As the material of the base member, a polyester resin such as PET can be used.

The forming of an intermediate layer is forming the intermediate layer 30 on the surface of the solid electrolyte layer 20 on a side opposite to the side of the positive electrode active material layer 12. As a method of forming the intermediate layer 30, a method of directly applying and drying an intermediate layer slurry on the surface of the solid electrolyte layer 20 or a method of transferring the intermediate layer 30 formed by applying and drying the intermediate layer slurry on the surface of a support sheet prepared separately to the surface of the solid electrolyte layer 20 with a predetermined pressure can be used. As the intermediate layer slurry, for example, a dispersion liquid of an intermediate layer formation material which contains a solvent, metal nanoparticles and amorphous carbon and optionally contains a binder can be used.

The forming of a negative electrode layer is forming the negative electrode layer 40 on the surface of the intermediate layer 30 on a side opposite to the side of the solid electrolyte layer 20. As a method of forming the negative electrode layer 40, a method of arranging the negative electrode current collector 41 prepared previously on the surface of the intermediate layer 30 can be used.

In this way, the electrode multilayer 1 is obtained in which the positive electrode layer 10, the solid electrolyte layer 20, the intermediate layer 30 and the negative electrode layer 40 are stacked in this order. The electrode multilayer 1 obtained may be arbitrarily pressed in the stacking direction such that the density of the electrode multilayer 1 is increased.

The solid-state secondary battery 100 can be produced as follows. An end portion of a positive electrode tab is connected to the positive electrode current collector 11 of the electrode multilayer 1 obtained, and an end portion of a negative electrode tab is connected to the negative electrode current collector 41. Then, the electrode multilayer 1 is housed in the exterior case 50 and the exterior case 50 is sealed such that the other end portions of the positive electrode tab and the negative electrode tab protrude. Then, the restrainers 60 are arranged on the outer surfaces of the exterior case 50, and thus the electrode multilayer 1 is restrained by the predetermined restraint force.

The forming of an intermediate layer and the forming of a negative electrode layer may be performed simultaneously. For example, the intermediate layer 30 of an intermediate layer-negative electrode layer multilayer obtained by previously integrating the intermediate layer 30 and the negative electrode layer 40 and making them independent may be arranged on the surface of the solid electrolyte layer 20. For example, the intermediate layer-negative electrode layer multilayer can be obtained by applying and drying the intermediate layer slurry to the surface of the negative electrode current collector 41 and thereby forming the intermediate layer 30.

In the solid-state secondary battery 100 of the present embodiment configured as described above, the areas of the positive electrode active material layer 12, the solid electrolyte layer 20, the intermediate layer 30 and the negative electrode layer 40 in plan view satisfy the relationship described above, and thus even when charging and discharging is repeated, the metal is unlikely to be accumulated at end portions of the solid electrolyte layer 20 and the intermediate layer 30. Hence, the positive electrode layer 10 and the negative electrode layer 40 are unlikely to be short-circuited, and thus the cycle characteristics are enhanced.

In the solid-state secondary battery 100 of the present embodiment, the distances from the center portions to the end portions of the positive electrode active material layer 12, the solid electrolyte layer 20, the intermediate layer 30 and the negative electrode layer 40 in the X direction and in the Y direction satisfy the relationship described above, and thus even when charging and discharging is repeated, the metal is unlikely to be accumulated at the end portions of the solid electrolyte layer 20 and the intermediate layer 30. Hence, the positive electrode layer 10 and the negative electrode layer 40 are more unlikely to be short-circuited, and thus the cycle characteristics are further enhanced.

Furthermore, in the solid-state secondary battery 100 of the present embodiment, the outer periphery of the positive electrode active material layer 12 is surrounded by the insulating frame 15, the distances from the center portions to the end portions of the insulating frame 15, the positive electrode active material layer 12, the solid electrolyte layer 20, the intermediate layer 30 and the negative electrode layer 40 in the X direction and in the Y direction satisfy the relationship described above and thus even when the metal is accumulated at the end portions of the solid electrolyte layer 20 and the intermediate layer 30, the metal is unlikely to extend around the positive electrode active material layer 12. Hence, the positive electrode layer 10 and the negative electrode layer 40 are more unlikely to be short-circuited, and thus the cycle characteristics are further enhanced.

In the method for manufacturing the solid-state secondary battery 100 in the present embodiment, the solid electrolyte layer 20, the intermediate layer 30 and the negative electrode layer 40 are formed on the positive electrode active material layer 12 in this order, and thus it is possible to industrially advantageously manufacture the solid-state secondary battery in which the areas of the solid electrolyte layer 20, the intermediate layer 30 and the negative electrode layer 40 in plan view satisfy a relationship of Sn≤Sm≤Ss.

Although the embodiment of the present invention has been described above, the present invention is not limited to the embodiment described above. For example, although in the solid-state secondary battery 100 of the present embodiment, the outer periphery of the positive electrode active material layer 12 is surrounded by the insulating frame 15, a configuration may be adopted in which the insulating frame 15 is not provided. Preferably, in this case, the end portion which is not in contact with the positive electrode active material layer 12 on the surface of the solid electrolyte layer 20 on the side of the positive electrode active material layer 12 is covered with an insulating material, and thus the metal is prevented from being precipitated between the end portion of the solid electrolyte layer 20 and the positive electrode active material layer 12. Preferably, the thickness of the positive electrode active material layer 12 and the thickness of the insulating material at the end portion are made equal to each other, and thus a step is prevented from being made when the electrode multilayer 1 is pressed, and thus the density thereof is increased.

Although in the solid-state secondary battery 100 of the present embodiment, the metal precipitation layer 42 is used as the negative electrode active material layer, the negative electrode active material layer is not limited to the metal precipitation layer 42. As the negative electrode active material layer, a layer may be used which includes a negative electrode active material capable of absorbing and releasing a charge transfer medium such as lithium ions. In this case, the negative electrode active material layer may be arranged on the surface of the current collection base member 41a. As the negative electrode active material, a negative electrode active material which is used in the negative electrode of a general solid-state secondary battery can be used. When the charge transfer medium is lithium ions, examples of the negative electrode active material include lithium transition metal oxides such as lithium titanate, transition metal oxides such as TiO₂, Nb₂O₃ and WO₃, SiO, metal sulfides, metal nitrides and carbon materials such as artificial graphite, natural graphite, graphite, soft carbon and hard carbon. In terms of enhancing the conductivity of the charge transfer medium, the negative electrode active material layer may optionally include a solid electrolyte. The negative electrode active material layer may optionally include a conductive aid in order to enhance the conductivity. Furthermore, for example, in terms of developing flexibility, the negative electrode active material layer may optionally include a binder. As the solid electrolyte, the conductive aid and the binder, a solid electrolyte, a conductive aid and a binder which are used in a general solid-state secondary battery can be used.

### EXAMPLES

The present invention will be described in detail below using Examples. However, the present invention is not limited to Examples below.

### Example 1

### [Production of Positive Electrode Layer]

As a positive electrode current collector, rectangular aluminum foil having a length of 30.0 mm in the X direction, a length of 30.0 mm in the Y direction and a thickness of 15 μm was prepared.

80 parts by mass of lithium nickel cobalt manganese composite oxide (NCM622) serving as a positive electrode active material, 17 parts by mass of argyrodite-type sulfide solid electrolyte serving as a solid electrolyte, 2 parts by mass of carbon black serving as a conductive aid and 1 part by mass of SBR (styrene butadiene rubber) binder serving as a binder were mixed. The resulting mixture was dispersed in 43 parts by mass of butyl butyrate, and thus a positive electrode active material layer slurry was prepared. The positive electrode active material layer slurry obtained was applied using a bar coater method to the center of the positive electrode current collector such that the length in the X direction was 20.0 mm, the length in the Y direction was 20.0 mm and the weight after drying was 27 mg/cm² and was dried, and thus a positive electrode active material layer was formed. In this way, a positive electrode layer was produced.

### [Installation of Insulating Frame]

An insulting sheet having a length of 30.0 mm in the X direction, a length of 30.0 mm in the Y direction and a thickness of 80 μm was prepared. In the center of the insulting sheet, an opening having a length of 20.0 mm in the X direction and a length of 20.0 mm in the Y direction was formed, and an insulating frame was produced. The insulating frame obtained was installed around the positive electrode active material layer.

### [Production of Solid Electrolyte Layer]

A dispersion liquid of argyrodite-type sulfide solid electrolyte (median diameter: 3 μm) was applied to a support sheet and was dried, and thus an argyrodite-type sulfide solid electrolyte layer was formed such that the length in the X direction was 27.0 mm, the length in the Y direction was 27.0 mm and the weight after drying was 20 mg/cm². The argyrodite-type sulfide layer formed on the support sheet was transferred to the center of the positive electrode active material layer, and thus a solid electrolyte layer was produced.

### [Production of Intermediate Layer]

A total of 95 parts by mass of Sn particles (median diameter: 0.07 μm) serving as metal nanoparticles and acetylene black (particle diameter: 0.05 μm) serving as amorphous carbon and 5 parts by mass of PVDF binder serving as a binder were mixed. The resulting mixture was dispersed in 1000 parts by mass of NMP (N-methyl-2-pyrrolidone), and thus an intermediate layer slurry was prepared. The intermediate layer slurry obtained was applied to base member foil by a gravure coater method such that the length in the X direction was 22.0 mm, the length in the Y direction was 22.0 mm and the weight after drying was 0.4 mg/cm² and was dried. The intermediate layer obtained was transferred to the center of the solid electrolyte layer, and thus the intermediate layer was produced.

### [Production of Negative Electrode Current Collector]

Multilayer foil obtained by stacking copper foil having a thickness of 10 μm and lithium foil having a thickness of 40 μm was prepared. The multilayer foil was cut into a size in which the length in the Y direction was 21.0 mm and the length in the Y direction was 21.0 mm, and thus a negative electrode current collector was produced. The negative electrode current collector obtained was arranged in the center of the intermediate layer such that the lithium foil was in contact with the intermediate layer. In this way, an electrode multilayer was obtained in which the positive electrode layer, the solid electrolyte layer, the intermediate layer and the negative electrode current collector were stacked in this order.

### [Production of Solid-State Secondary Battery]

The electrode multilayer obtained as described above was pressed and thus the density thereof was increased, then tabs were attached to the positive electrode current collector and the negative electrode current collector and thereafter the electrode multilayer was stored in a laminate pack. Thereafter, the laminate pack was sealed under an argon atmosphere. The thicknesses of the layers after being pressed are shown in Tables 1 to 3.

A restrainer having a length of 21.00 mm in the X direction and a length of 21.00 mm in the Y direction was prepared. The restrainer was arranged from the surface of the laminate pack opposite the negative electrode current collector of the electrode multilayer, and a restraint force of 3 MPa was applied to the electrode multilayer, with the result that a solid-state secondary battery was produced.

### Examples 2 to 5

Solid-state secondary batteries were produced in the same manner as in Example 1 except that the dimensions of the positive electrode current collector, the positive electrode active material layer and the insulating frame were changed to dimensions list in Table 1, the dimensions of the solid electrolyte layer and the intermediate layer were changed to dimensions list in Table 2 and the dimensions of the negative electrode current collector and the restrainer were changed to dimensions list in Table 3.

### <Battery Properties>

For the solid-state secondary batteries produced in Examples 1 to 5, a cycle test was conducted in which charging and discharging was repeated at a charging upper limit voltage of 4.3 V, a discharging lower limit voltage of 2.65 V and a C rate of 1/3 C. The ratio of a discharge capacity to a charge capacity in the second cycle (discharge capacity/charge capacity×100) was calculated. The results thereof are shown in Table 3 as second charging/discharging efficiency.

TABLE 1

| | | | Example 1 | Example 2 | Example 3 | Example 4 | Example 5 |
|---|---|---|---|---|---|---|---|
| Positive | Dimensions | X | 30.0 | 56.0 | 140.0 | 140.0 | 140.0 |
| electrode | | direction | | | | | |
| current | | (mm) | | | | | |
| collector | | Y | 30.0 | 56.0 | 40.0 | 40.0 | 40.0 |
| | | direction | | | | | |
| | | (mm) | | | | | |
| | | Thickness | 15 | 15 | 15 | 15 | 15 |
| | | (μm) | | | | | |
| Positive | Dimensions | X | 20.0 | 50.0 | 115.0 | 118.0 | 118.0 |
| electrode | | direction | | | | | |
| active | | (mm) | | | | | |
| material | | Y | 20.0 | 50.0 | 23.0 | 23.5 | 25.0 |
| layer | | direction | | | | | |
| | | (mm) | | | | | |
| | | Thickness | 80 | 80 | 80 | 80 | 80 |
| | | (μm) | | | | | |
| | Distance | X | 10.0 | 25.0 | 57.5 | 59.0 | 59.0 |
| | from center | direction | | | | | |
| | portion to | Y | 10.0 | 25.0 | 11.5 | 11.8 | 12.5 |
| | end | direction | | | | | |
| Insulating | Dimensions | X | 30.0 | 56.0 | 140.0 | 140.0 | 140.0 |
| frame | | direction | | | | | |
| | | (mm) | | | | | |
| | | Y | 30.0 | 56.0 | 40.0 | 40.0 | 40.0 |
| | | direction | | | | | |
| | | (mm) | | | | | |
| | | Thickness | 80 | 80 | 80 | 80 | 80 |
| | | (μm) | | | | | |
| | Distance | X | 15.0 | 28.0 | 70.0 | 70.0 | 70.0 |
| | from center | direction | | | | | |
| | portion to | Y | 15.0 | 28.0 | 20.0 | 20.0 | 20.0 |
| | end | direction | | | | | |

TABLE 2

| | | | Example 1 | Example 2 | Example 3 | Example 4 | Example 5 |
|---|---|---|---|---|---|---|---|
| Solid | Dimensions | X | 27.0 | 55.0 | 120.0 | 120.0 | 120.0 |
| electrolyte | | direction | | | | | |
| layer | | (mm) | | | | | |
| | | Y | 27.0 | 55.0 | 30.0 | 32.0 | 32.0 |
| | | direction | | | | | |
| | | (mm) | | | | | |
| | | Thickness | 100 | 100 | 30 | 30 | 30 |
| | | (μm) | | | | | |
| | Distance | X | 13.5 | 27.5 | 60.0 | 60.0 | 60.0 |
| | from center | direction | | | | | |
| | portion to | Y | 13.5 | 27.5 | 15.0 | 16.0 | 16.0 |
| | end | direction | | | | | |
| | portion (mm) | | | | | | |
| Intermediate | Dimensions | X | 22.0 | 54.5 | 120.0 | 120.0 | 120.0 |
| layer | | direction | | | | | |
| | | (mm) | | | | | |
| | | Y | 22.0 | 54.5 | 30.0 | 32.0 | 32.0 |
| | | direction | | | | | |
| | | (mm) | | | | | |
| | | Thickness | 3 | 3 | 3 | 3 | 3 |
| | | (μm) | | | | | |
| | Distance | X | 11.0 | 27.3 | 60.0 | 60.0 | 60.0 |
| | from center | direction | | | | | |
| | portion to | Y | 11.0 | 27.3 | 15.0 | 16.0 | 16.0 |
| | end | direction | | | | | |
| | portion (mm) | | | | | | |

TABLE 3

| | | | Example 1 | Example 2 | Example 3 | Example 4 | Example 5 |
|---|---|---|---|---|---|---|---|
| Negative | Dimensions | X | 21.0 | 54.0 | 120.0 | 120.0 | 120.0 |
| electrode | | direction | | | | | |
| current | | (mm) | | | | | |
| collector | | Y | 21.0 | 54.0 | 30.0 | 32.0 | 32.0 |
| | | direction | | | | | |
| | | (mm) | | | | | |
| | | Thickness | 10 | 10 | 10 | 10 | 10 |
| | | (μm) | | | | | |
| | Distance | X | 10.5 | 27.0 | 60.0 | 60.0 | 60.0 |
| | from center | direction | | | | | |
| | portion to | Y | 10.5 | 27.0 | 15.0 | 16.0 | 16.0 |
| | end | direction | | | | | |
| | portion (mm) | | | | | | |
| Restrainer | Dimensions | X | 21.0 | 54.0 | 120.0 | 120.0 | 120.0 |
| | | direction | | | | | |
| | | (mm) | | | | | |
| | | Y | 21.0 | 54.0 | 30.0 | 32.0 | 32.0 |
| | | direction | | | | | |
| | | (mm) | | | | | |

| | | | | | | |
|---|---|---|---|---|---|---|
| Battery | Second | 98.9 | 98.1 | 98.5 | 98.0 | 98.2 |
| properties | charging/discharging | | | | | |
| | efficiency (%) | | | | | |

It is found from the results of the battery properties shown in Table 3 that the solid-state secondary batteries of Examples 1 to 5 in which all the dimensions of the positive electrode active material layer, the solid electrolyte layer, the intermediate layer and the negative electrode current collector are in the ranges of the present invention have high values of the second charging/discharging efficiency.

### EXPLANATION OF REFERENCE NUMERALS

1 electrode multilayer
10 positive electrode layer
11 positive electrode current collector
12 positive electrode active material layer
15 insulating frame
20 solid electrolyte layer
30 intermediate layer
40 negative electrode layer
41 negative electrode current collector
41a current collection base member
41b metal layer
42 metal precipitation layer
50 exterior case
60 restrainer
100 solid-state secondary battery

What is claimed is:

1. A solid-state secondary battery comprising: an electrode multilayer; and an exterior case that houses the electrode multilayer,
wherein the electrode multilayer comprises a positive electrode layer, a negative electrode layer, a solid electrolyte layer arranged between the positive electrode layer and the negative electrode layer and an intermediate layer provided between the negative electrode layer and the solid electrolyte layer,
the positive electrode layer comprises a positive electrode current collector and a positive electrode active material layer and
when an area of the positive electrode active material layer in plan view is Sp, an area of the solid electrolyte layer in plan view is Ss, an area of the intermediate layer in plan view is Sm and an area of the negative electrode layer in plan view is Sn, a relationship of Sp<Sn≤Sm≤Ss is satisfied.

2. The solid-state secondary battery according to claim 1, wherein the Sm and the Sn satisfy a relationship Sn<Sm.

3. The solid-state secondary battery according to claim 1, wherein when a direction parallel to an upper surface of the electrode multilayer viewed in plan view is a first direction, a distance from a center portion to an end portion of the positive electrode active material layer in the first direction is Xp, a distance from a center portion to an end portion of the solid electrolyte layer in the first direction is Xs, a distance from a center portion to an end portion of the intermediate layer in the first direction is Xm and a distance from a center portion to an end portion of the negative electrode layer in the first direction is Xn, a relationship of Xp<Xn≤Xm≤Xs is satisfied, and
when a direction which is parallel to the upper surface of the electrode multilayer viewed in plan view and is orthogonal to the first direction is a second direction, a distance from a center portion to an end portion of the positive electrode active material layer in the second direction is Yp, a distance from a center portion to an end portion of the solid electrolyte layer in the second direction is Ys, a distance from a center portion to an end portion of the intermediate layer in the second direction is Ym and a distance from a center portion to an end portion of the negative electrode layer in the second direction is Yn, a relationship of Yp<Yn≤Ym≤Ys is satisfied.

4. The solid-state secondary battery according to claim 3, wherein the Xm and the Xn satisfy a relationship Xn<Xm and the Ym and the Yn satisfy a relationship Yn<Ym.

5. The solid-state secondary battery according to claim 1, wherein an outer periphery of the positive electrode active material layer is surrounded by an insulating frame.

6. The solid-state secondary battery according to claim 5, wherein when a direction parallel to an upper surface of the electrode multilayer viewed in plan view is a first direction, a distance from a center portion to an end portion of the insulating frame in the first direction is Xi, a distance from a center portion to an end portion of the positive electrode active material layer in the first direction is Xp, a distance from a center portion to an end portion of the solid electrolyte layer in the first direction is Xs, a distance from a center portion to an end portion of the intermediate layer in the first direction is Xm and a distance from a center portion to an end portion of the negative electrode layer in the first direction is Xn, a relationship of Xp<Xn≤Xm≤Xs<Xi is satisfied, and
when a direction which is parallel to the upper surface of the electrode multilayer viewed in plan view and is orthogonal to the first direction is a second direction, a distance from a center portion to an end portion of the insulating frame in the second direction is Yi, a distance from a center portion to an end portion of the positive electrode active material layer in the second direction is Yp, a distance from a center portion to an end portion of the solid electrolyte layer in the second direction is Ys, a distance from a center portion to an end portion of the intermediate layer in the second direction is Ym and a distance from a center portion to an end portion of the negative electrode layer in the second direction is Yn, a relationship of Yp<Yn≤Ym≤Ys<Yi is satisfied.

7. The solid-state secondary battery according to claim 1, wherein a thickness of the intermediate layer in a stacking direction of the electrode multilayer is equal to or less than 5 μm.

8. The solid-state secondary battery according to claim 1, wherein the intermediate layer comprises metal nanoparticles and amorphous carbon.

9. The solid-state secondary battery according to claim 1, wherein a ratio of a thickness of the positive electrode layer to a thickness of the negative electrode layer in a discharged state is equal to or greater than 1.9.

10. The solid-state secondary battery according to claim 1, comprising: a restrainer that provides a restraint force to the electrode multilayer in a stacking direction of the electrode multilayer,
wherein when an area of the restrainer in plan view is Sr, a relationship of Sn≤Sr is satisfied.

11. A method for manufacturing a solid-state secondary battery, the method comprising: preparing a positive electrode layer that comprises a positive electrode current collector and a positive electrode active material layer;
forming a solid electrolyte layer on a surface of the positive electrode active material layer of the positive electrode layer;
forming an intermediate layer on a surface of the solid electrolyte layer on a side opposite to a side of the positive electrode active material layer; and
forming a negative electrode layer on a surface of the intermediate layer on a side opposite to a side of the solid electrolyte layer.
